(19) United States
(12) Patent Application Publication
(10) Pub. No.: US 2010/0004498 A1
(43) Pub. Date: Jan. 7, 2010

(54) Reducing the profile of neutron-activated 60Co and removing in layers at the primary system of a permanently shut down nuclear power plant in order to accelerate its dismantling

(76) Inventor: Walter Binner, Vienna (AT)

Correspondence Address: K.F. ROSS P.C., 5683 RIVERDALE AVENUE, SUITE 203 BOX 900, BRONX, NY, 10471-0900, US

(21) Appl. No.: 12/484,342

(22) Filed: Jun. 15, 2009

(30) Foreign Application Priority Data
Jul. 1, 2008 (AT) A1041/2008

(51) Int. Cl. G21F 9/16

(52) U.S. Cl. 588/4

(57) ABSTRACT

The Decommissioning Phase SAFSTOR for Nuclear Power Plants, lasting for 50 to 60 years before dismantling begins, is to allow for natural decay of ⁶⁰Co, a constituent of reactor steel to roughly 1/1000^{th} of its original content. This can be sped up partly by minimizing its build-up in the Reactor Pressure Vessel and in the Biological Shield, partly by reducing its higher contents in the former by milling/cutting from its inner side. The outer rise of the activity (65, in FIG. 10) in the Reactor Pressure Vessel is caused by the back flow of thermalized neutrons (66) from the Biological Shield (67). An absorber (68), added to the inner liner (69), causes by blocking off this flow of neutrons a steady decline of the Co-distribution with its minimum at the outer side of the wall (70). Then, milling/cutting on the inside removes most of the ⁶⁰Co exclusively from the inside of the Reactor Pressure Vessel. An absorbing material inserted into the concrete causes within the Biological Shield an equivalent drop of activity. By these methods the 5 to 10 year long dismantling phase DECON can begin after shut down. The introduction of the absorbers as proposed has no repercussions on the general concept and design of the Nuclear Power Plant and a substantial reduction of costs is achievable.

### 1. THE TECHNICAL DOMAIN

The primary technical domain is the Decommissioning and Dismantling (D&D) of a retired Nuclear Power Plant (NPP). There is not yet a commonly employed method to that end, but there are individually varying procedures¹. The main object of D&D is the restoration of the site to its original condition and the secure shipment of the demolition debris to a site equipped for waste disposal. The time scales of the various methods vary substantially. By an accelerated dismantling one could, among other things, also regain a site for a new NPP, otherwise a rather difficult task. Furthermore, by beginning D&D early the personnel is still available who know the plant, as well as the intact Safety Containment and the plant's infrastructure (cranes and hoists, electric and electronic systems, heating, cooling, ventilating, air conditioning [HVAC], metrology installations, spare parts, radiation protection, controlled areas and so on) that would still be operable. Also at hand are the manufacturers who are still informed about the plant and who, if necessary, are in the position to replace technical equipment. Years later, all or part of this infrastructure might not be so easily available and would have to be reorganized from scratch with substantial cost.

An accelerated dismantling should be more cost-saving than a delayed decommissioning. Other factors beyond the plant proper, among them radiation protection for the public, the environment's infrastructure, the political background play an important role, too². In case of a late D&D, the permanent spectacle of a retired and unused NPP creates an additional burden to Nuclear Technology with the stigma of a smoldering site signifying the high potential of danger. An early dismantling, on the other hand, becomes the more appealing the more cleansing the environment turns into a paradigm. Preceding this application, one of the methods for a patent for an accelerated dismantling was presented by the applicant for this patent at a special session dealing with D&D at the Winter Meeting 1994 of the American Nuclear Society and was published in its Transactions and in the Proceedings³.

The above mentioned individually distinct methods of D&D are classified in the USA (and in the International Atomic Energy Agency—IAEA) in the following three categories (literal quote)⁴:
DECON (Decontamination). In DECON, all components and structures that are radioactive are cleaned or dismantled, packed and shipped to a low-level waste disposal site, or they are stored temporarily on site. Once this task—which takes five or more years—is completed and the NRC terminates the plant's license, that portion of the site can be reused for other purposes.
SAFSTOR (Safe Storage). In SAFSTOR, the nuclear plant is kept intact and placed in protective storage for up to 60 years. This method, which involves locking the part of the plant containing radioactive materials and monitoring it with an on-site security force, uses time as a decontaminating agent—the radioactive atoms “decay” by emitting their extra energy to become non radioactive or stable atoms. If a plant is allowed to sit idle for 30 years, for example, the radioactivity from cobalt-60 will be reduced to 1/50^{th} of its original level; after 50 years, the radioactivity will be just 1/1000^{th} of its original level. Once radioactivity has decayed to lower levels, the unit is taken apart similar to DECON.
ENTOMB. This option involves encasing radioactive structures, systems and components in a long-lived substance, such as concrete. The encased plant would be appropriately maintained, and surveillance would continue until the radioactivity decays to a level that permits termination of the plant's license. In 1999, the NRS found that entombment might be a viable decommissioning option and held a public workshop to explore the issue. In late 2001, the NRC published an advance notice of proposed rulemaking to solicit additional public input. The industry commented that some form of this option should be established in regulation.

### 2. THE PRESENT STATE OF TECHNOLOGY

As stated, there is no concerted picture on the D&D of NPPs up to now. At present (2008), the USA has the highest number of retired Nuclear Power Plants, 24 all together, that are in various stages of D&D. 11 of them are in SAFSTOR, 4 in DECON and the rest are in a state in between, characterized also by storing the used fuel temporarily on site⁵. Evidently, as it follows from the above-mentioned categories, the radionuclide ⁶⁰Co, that is present in the various components, plays an especially important role. It is the reason that SAFSTOR, that lasts 50 to 60 years, precedes the dismantling proper.

SAFSTOR should enable the “cooling down” of built-up radioactivity, especially of the radionuclide ⁶⁰Co, before dismantling starts⁶. With a half life of 5.3 years it is relatively short-lived; although causing substantial radiation doses at the beginning; it decays after 53 years to about 1/1000^{th} of its original amount. ⁶⁰Co is formed from the stable ⁵⁹Co by absorbing a thermal neutron that penetrates into the steel parts of the reactor. ⁵⁹Co is contained in the ground steel and in the stainless steel of the RPV-plating and also in the concrete structures. Its percentage in the carbon steel is with 0.006 to 0.012% relatively low but the absorption coefficient for thermal neutrons with 35 b (1 b=10⁻²⁴ cm²) is high; so this leads to a high activity. After 10 half lives it decays, as mentioned, to about 1/1000^{th} of its original value, its activity being surpassed after that time by much longer lived radionuclides (such as ⁹⁴Nb with a half life of 20,000 years and so on) so no further delay of D&D makes sense.

Because the neutrons penetrate the steel, it follows that the activation of nuclides is not only restricted to surfaces but spread throughout the steel parts where they are exposed to the neutron flux. This makes D&D more difficult. As far as the RPV is concerned, it is not only its activation that is the problem but also its weight (up to 500 tons, its size from 10 to 20 m, with a diameter of 4 to 5 m and with wall thicknesses up to 25 cm) and its deep imbedding within the structures of a NPP. Used fuel and reactor internals are-much more activated but they will be removed from the RPV after the final shut down of the plant, the fuel routinely with specific tools, the reactor internals with the use of tools and procedures, some of them matured and some being in the state of development^{7,8,9}. In this way about 99% of the radioactivity of the plant can be removed. One percent of activity, however (that is still a big amount), remain in the plant. The most important remaining activity is from the ⁶⁰Co within the mass of the RPV that is now emptied of fuel and internals. The reduction of this ⁶⁰Co by natural decay to 1/1000^{th} of its original value is, then, the main purpose of the phase SAFSTOR.

Not too many NPPs worldwide have been dismantled, nor are there, up to now, plans how others be dismantled. Examples are the Pressurized Water Reactor (PWR) BR-3, a Westinghouse plant of 41 MWth in Belgium that was in operation from 1962 to 1987. Its D&D is (in part) financed by the European Union; the RPV is to be segmented into manageable pieces and safely stored^{10,11}. A well known dismantling project is the 250 MWe Boiling Water Reactor (BWR) Gundremmingen-A in Germany that was in operation from 1966 to 1977 and was decommissioned in 1983^{12,13}. Its RPV will be sectioned mechanically in the core region and thermally in the regions above and below, the segments will then, under protective shielding, be transferred to an external waste disposal. The RPV of Yankee Rowe Nuclear Power Station, a Westinghouse PWR of about 250 MWe was in operation from 1961 to 1992, its RPV, emptied of its internals, was removed in one piece from the plant, stored at the site and, in 1997, transported to a Low Level Waste (LLW) disposal site in South Carolina¹⁴. San Onofre Unit 1, a PWR with 1347 MWe, in operation from 1968 until 1992, was put into SAFSTOR in 1994. The RPV was removed from the plant and is placed on site for indefinite time due to its size and weight. The RPV of the NPP Trojan, a PWR of 1130 MWe, was in operation from 1976 until 1993. Its RPV, including its internals, was in 1999 as a 1000 ton one piece load transported on a special barge, pulled by two tug boats, over a 270 mile stretch up the Columbia river and then 30 miles over land to a LLW site near Richland, Wash.¹⁵. All this shows there exist problems, especially with RPVs.

Evidently with these difficulties with the D&D of the RPV's of larger units in mind, EPRI (Electric Power Research Institute—the Research and Development institution of the US-utilities) issued in July/August 2006 the following view¹⁶:
Although most decommissioned plants on single unit site in the United States are opting for rapid deconstruction, reactor pressure vessel (RPV) extended SAFSTOR options may be desirable for decommissioning plants with disposal and/or transportation limitations. Also, dose and cost savings may result by delaying some segmentation tasks until significant radionuclide decay has occurred. A recent evaluation of the impact of RPV SAFSTOR strategies for PWRs and BWRs concluded that RPV SAFSTOR may be a desirable option for decommissioning plants in certain circumstances, in particular for BWRs due to the radiological characteristics of their larger RPVs.

So if a rapid deconstruction of single units is intended by their owners there would be, in the view of EPRI, the need for action involving radiation protection and cost savings. A further remark of EPRI, however, also published in the article mentioned, albeit related to the field of surface decontamination, speaks for an accelerated D&D of an RPV:
EPRI has good methods and experiences with three nuclear power plants in view of the chemical decontamination processes of the reactor coolant systems:
   Apply as soon as possible after final closure, when equipment is still operable, expert staff are available, and exposure savings are maximized.
   Use reactor coolant pumps, as good fluid circulation is important.

In the German patent DE-4437276 C 2, issued in May 2000 (abandoned by its former owner, evidently because no pilot project was acquired), a method of metal cutting or milling was presented to reduce the activation and the material of a retired RPV¹⁷. The state of the art at this time was described in that patent evaluation as follows: EP-A-0248286 describes a method of disposing of the waste, possibly after segmentation; DE-C2-2907738 is a top down reduction of an activated container using a solidifying material, its activated level being lowered following the process of the demolition; CH-A-597675 the severance (with various methods, metal cutting being one of them) of the larger parts of a Nuclear Power Plant and their disposal in a basin. Each of these methods, as the German patent states, has various disadvantages, such as differently activated parts, unhandy dimensions, differing manipulation steps up to the final disposal, and so on. DE-A-3916186 describes a method to remove surface layers, DE-A-3417145 a device for the fragmentation of the material of the pressure vessel into handy sizes and its eventual disposal, EP-A-0116663 the removal of oxide layers up to 3 mm by means of a pressure water jet, and DE-A-2726206 the electrolytic removal of inner layers with a subsequent blast in order to induce a brittle fracture of the RPV.

None of these methods was seen by the German patent office as a hindrance for granting the said patent (disclosure in April 1996). The metal cutting of the activated areas of a RPV by mechanical means and the subsequent shipment of the shielded cuttings to a LLW disposal site were the main content of that German patent. In the first place, the cutting process serves the purpose of reducing the activity, in the second place the reduction of mass. The latter alone would also be possible using the present state of technology, although very complicated due to the high radiation (that eventually lead to the concept SAFSTOR). Also in this present application the method of a mechanical cutting process is proposed. Cutting is to be performed from within the water-filled RPV, as long as the wall, progressively thinned by the cutting process, continued to maintain the geometric form with the water tightness intact. The water and the working platform above the RPV ensures radiation protection of the personnel. An advantage of the mechanical cutting, as mentioned in a Japanese publication, is the avoidance of smoke, aerosols and dust¹⁸. A goal of milling down to a minimum activity (not only of ⁶⁰Co) is 1/1000^{th} of the original value is equivalent to an artificial aging of 50 to 60 years as proposed by SAFSTOR. The German patent mentioned focused primarily on a cutting process alone from the inside of the RPV.

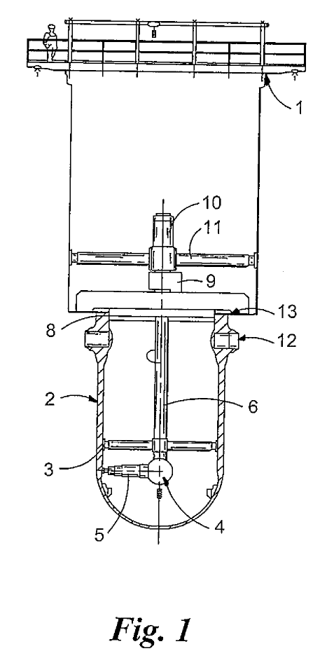

As shown in FIG. 1, the cutting process is performed by remote control from a working platform (1) above the water-filled RPV (2), and the cutting tool (3), mounted on a mobile head (4), is moved into the working area (5). The device is operated on a guiding pole (6) and stabilized by a vibration damper (7) and a fixture (8). The milling cutter (9) is moved by an advance in the vertical direction. On the upper end of the pole there is the driving motor (10) located above a mounting (11). The water-filled tank and the working platform serve also as radiation protection. The RPV is still tied to the hot and the cold coolant lines (12), the water is to be filled up to the flange of the RPV lid or beyond (13). The former owner of the German patent made the assessment, on the basis of his checks and tests, that reducing the RPV-wall to a 60 mm thickness would take from two to three months¹⁹. Working procedures and the necessary tools were described in a publication²⁰ that dealt with the cutting of the highest activated parts from the inside of the RPV. The cuttings were to be collected under water by a suction device, packed into a shielded container and shipped into a LLW disposal.

Later, in 1999, a description of this method of dismantling a RPV on the basis of metal cutting appeared in a publication of the IAEA²¹. With regard to the development of the state of D&D since, a conference in 2002 in Berlin²² dealt with that subject. There Ishikura pointed out the deconstruction of RPVs as one single piece in the USA. He referred to the removal of the RPV of the (small) Yankee Rowe Plant after it was emptied of the core internals and disposed of at a LLW site, the removal of the big RPV of the Trojan plant (shipped, as said, including the core internals to a LLW site) and the removal of the RPV San Onofre (stored on site). It was emphasized that any experience with the dissection of a RPV in the USA at that time was limited. On an international scale was mentioned the plan to store the RPV Loviisa (Finland) as one piece on the site. This kind of D&D would lessen the risks of transportation but there might be no cost advantages because of the size and the activation of the RPV (See chapter 7 concerning Trojan). Two further conferences on that subject took place in 2006; in neither of them was any precedence to the subject of this application.^{23,24}.

### 3. THE TECHNICAL REASON FOR THE INVENTION

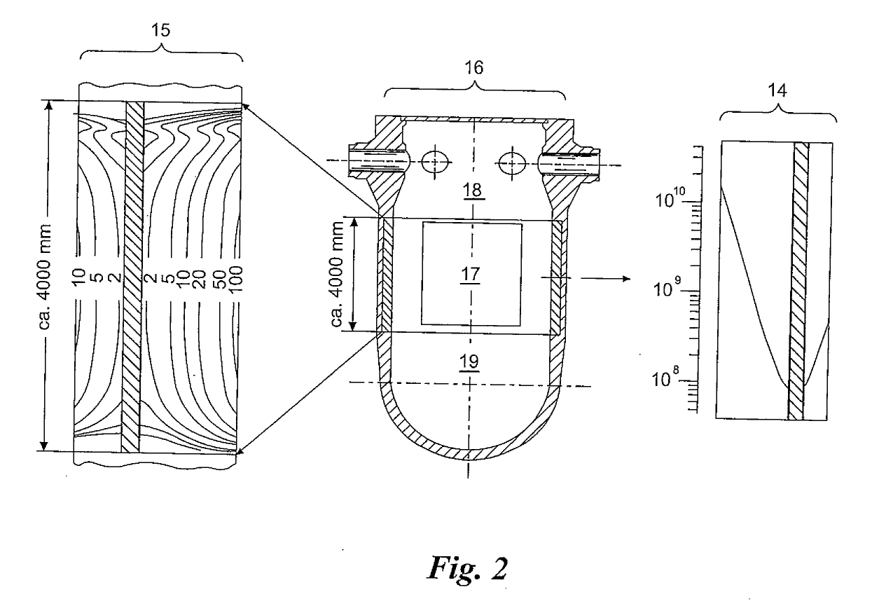

Metal cutting, if intended to reach the minimum distribution of ⁶⁰Co, as suggested in the German patent, could not, however, proceed close to the outer edge of the RPV-wall, because this minimum lies inside the wall of the RPV from which the ⁶⁰Co-distribution rises again to the outer edge. This is shown in FIG. 2 by means of two cross sections of the wall. The right one (14), mid-plane at the height of the reactor core (17), shows the course of the thermal neutron flux (assumed to be proportional to the neutron fluence) across the wall, in logarithmic scale, the higher value inside. The flux decreases towards the upper (18) and the lower (19) core grid plate, but it shows on every level the same characteristic unsymmetrical U-shaped form throughout the core. This results in the formation of ⁶⁰Co throughout the reactor core, shown on the left side (15), roughly in Curie/m³ as an equilibrium distribution (neutron activation minus decay) proportional to the neutron fluence. Because of this increase of activity at the outer edge of the RPV, in order to remove an optimum amount of it down to the fluence minimum, an equivalent cutting process from the outside of the RPV towards the minimum distribution of ⁶⁰Co ought to be carried out, too. Then, the total cutting process should proceed as far as the shaded area in (14) and (15) shows. Such a procedure performed also from the outside was described in the German patent.

Cutting/milling from the outside, however, is definitely more complicated than from the inside: The position outside the RPV is less simple, the enclosure might not be watertight as it is from the inside, and the pipes of the primary system are in the way so that disconnecting the RPV from the primary system might be necessary. Therefore, eventually the idea was conceived that one ought to be content with the cutting process from the inside of the RPV only, especially since plants to be subjected to D&D have long been out of operation and the ⁶⁰Co has already undergone substantial decay.

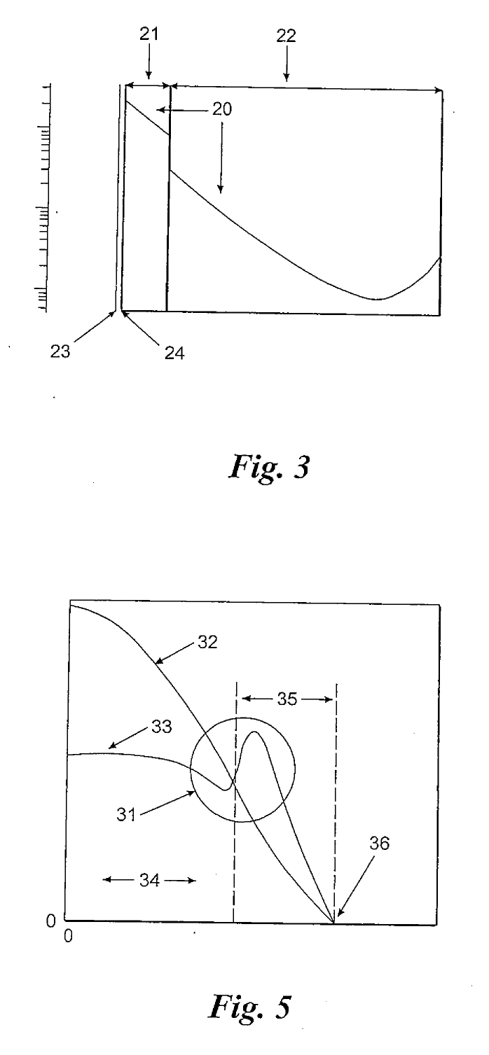

In addition, the inner plating (21) of stainless steel as shown in FIG. 3 has a cobalt content about 10 times higher than in the ground material (22), so that cutting from the inside is sufficient to remove the major part of the activity. FIG. 3 shows schematically the distribution of ⁶⁰Co throughout the RPV-wall (20) depending not only on the neutron fluence but also from the material composition, so an increase of the factor 10 in the plating is understandable. FIG. 3 shows its course (20) within the plating (21) (the width of which is presented overproportionally) and in the ground material (22). For the sake of completeness, the surface contamination of layers of deposited activated material of 10 μm thickness, and the same extent of corrosion, must be mentioned, too; these can also be removed from the inner wall. Their contribution to the total activity of the RPV might be around 1%, the activation within the wall amounts to 99%.

An inner cutting alone might therefore be sufficient to remove a substantial amount of activated material anyway. The radiation burden on the outside of the RPV, however, cannot in this way be reduced to a possible minimum and also the process might fail short of the reduction goal of 1/1000^{th} of the original activation. It ought to be mentioned that the cutting/milling process from the inside alone, and/or additionally from the outside, also removes the other longer lived neutron activated radionuclides (for example ⁹⁴Nb with a half life of 50,000 years) in the same proportion as with ⁶⁰Co that would not even be the case with SAFSTOR.

### 4. THE NOVELTY OF THE INVENTION

Following the proposal to remove the activity by cutting, there arises the question: what after all causes the increase of the ⁶⁰Co-content (and that of other radionuclides) towards the outside of the RPV? Why, in other words, is there an increase of the thermal neutron flux (resp. the fluence)? Moreover, would it be possible to suppress this increase and to see whether or not the minimum of the activity within the RPV-wall could possibly be shifted to the outer side of the RPV? This patent application deals with this problem: As soon as the minimum of the ⁶⁰Co activity reaches the outer edge of the RPV-wall metal cutting/milling solely from the inside of the RPV could lead to an optimum reduction of the ⁶⁰Co. This would be an essential simplification of the dismantling process (such a simplification would also be of importance in view of the lateral variation of the activity). An even more important simplification of the whole D&D process, as will be shown, would be to have no need of a severance of the RPV from the primary circuit so that the cutting could be done from its inside alone.

To enable the shift of the minimum of the ⁶⁰Co activity to the outer side of the RPV as a consequence of shifting the thermal neutron flux distribution in that direction, the reason for the increase of the latter must first be found. This cannot be seen as an isolated problem but only as a part of the whole system: Reactor—RPV—Biological Shield. First of all, the characteristic U-shaped course of the thermal neutron flux with its minimum within the RPV-wall appears in all reactor systems with Light Water Reactors^{25,26,27,28}, with PWRs as well as with BWRs. It is therefore a generic problem.

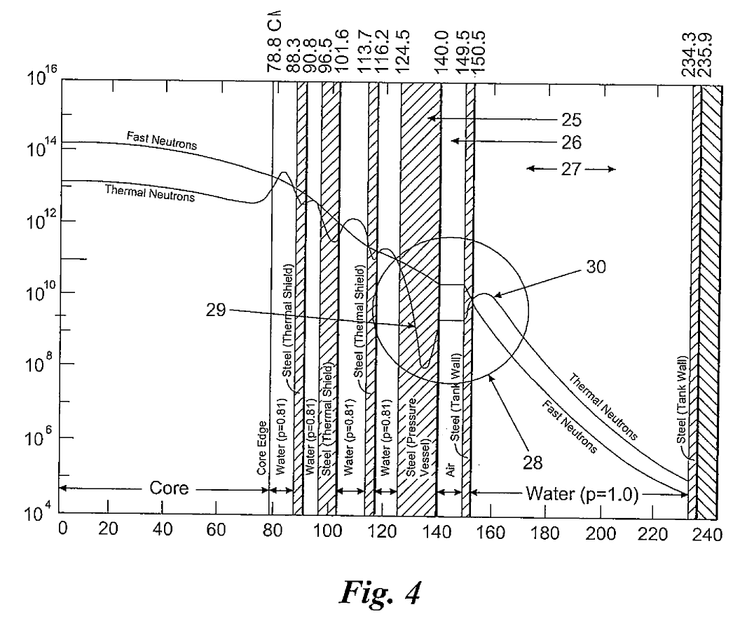

One can see this in detail and comprehensively in the illustration “Fast and thermal flux distribution in the shield of a 70 MW reactor,” an early power reactor, in FIG. 4²⁸. It shows the course of the fast neutron flux and of the thermal neutron flux in a logarithmic scale as neutrons/cm²sec depending on its distance from the center line of the reactor in cm. The RPV (25) and the air gap (26) that separates the RPV from the Biological Shield, that in this case is a layer of water (27), are for the purpose of this investigation the most interesting parts and are therefore accentuated by the circle (28). One recognizes the characteristic asymmetrical U-formed shape of the thermal neutron flux (29) and its pronounced increase in the opposite biological shield (30). This is characteristic of present day power reactors with massive Reactor Pressure Vessels and with Biological Shields of reinforced concrete^{25,2627}.

The decline of the fast neutron flux shown in FIG. 4 is more or less steady due to the fact that, with high neutron energies, the scattering and the absorption cross sections in the various regions, in the steel and in the concrete, are rather small and do not differ too much from each other. The air space (assumed to be empty) between the RPV and the Biological Shield produces, due to the absence of matter, clearly no alteration of the fluxes, and neutron flux and neutron current are the same on both face sides. So there is a continuous and steady transition of them. Ignoring now the air gap it becomes obvious that the rise of the thermal neutron flux in the RPV toward its outer edge is caused by the neutron diffusion from the higher thermal flux in the Biological Shield (the water zone) into the RPV. Were the Biological Shield made of concrete instead of water the conditions would be the same since scattering and absorption cross sections of the fast flux are small and similar in both of them.

Now it can be seen that the situation within the circle (31) of FIG. 4 (without the air gap) is analogous to the one of a system Core-Reflector as in FIG. 5. There, fast neutron flux (32) and thermal neutron flux (33) show qualitatively behaviors like those in FIG. 4. This can be assessed analytically as a result of a two-group calculation with four differential equations of the diffusion type two apiece for the fast and the thermal neutron flux in the core (34) and in the reflector (35), with the boundary conditions of steadiness of the fast and of the thermal neutron flux and of the neutron current density at the interface core-reflector. Both neutron fluxes (symmetrical or finite depending on the geometry) are coupled by tying both to zero at the extrapolation distance (36). In the technical literature this problem is extensively treated^{29,30}. A typical result is depicted graphically in FIG. 5 and is interpreted as follows³⁰:
It will be observed that the slow neutron flux exhibits a maximum in the reflector at a short distance from the core-reflector interface [the circular area in FIG. 5]. This arises from the fact that in the reflector slow neutrons are produced by the slowing down of fast ones, but they are absorbed very much less strongly in the reflector than in the core . . . .

In another reference this is described in this way²⁹:
It will also be observed . . . that there is a . . . peak in the thermal flux in the reflector . . . . The peaking of the thermalflux arises from the slowing down in the reflector of fast neutrons which escape the core. Since the absorbtion cross section of the reflector is small, the thermalized neutrons accumulate in this region until they eventually diffuse back into the core

Thus, due to the retrodiffusion of thermalized neutrons and due to the steadiness of neutron flux and of neutron current density at the interface Core-Reflector there results an increase of the thermal flux in the part of core (34) that is close to the reflector (35). This is shown in FIG. 5 and it is described by Glasstone-Edlund and Lamarch as just quoted. The same behavior is precisely that described in this patent proposal, as shown in the circle in FIG. 4, for the area RPV—Air Gap—Biological Shield.

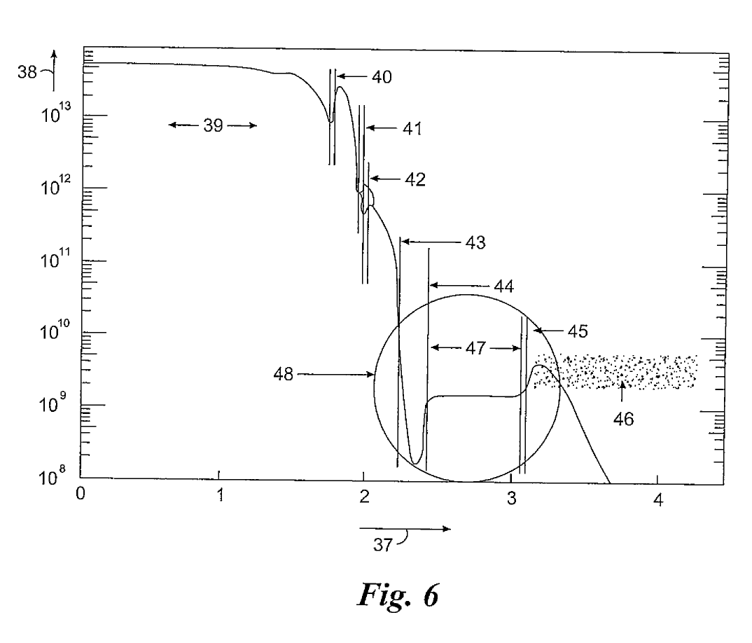

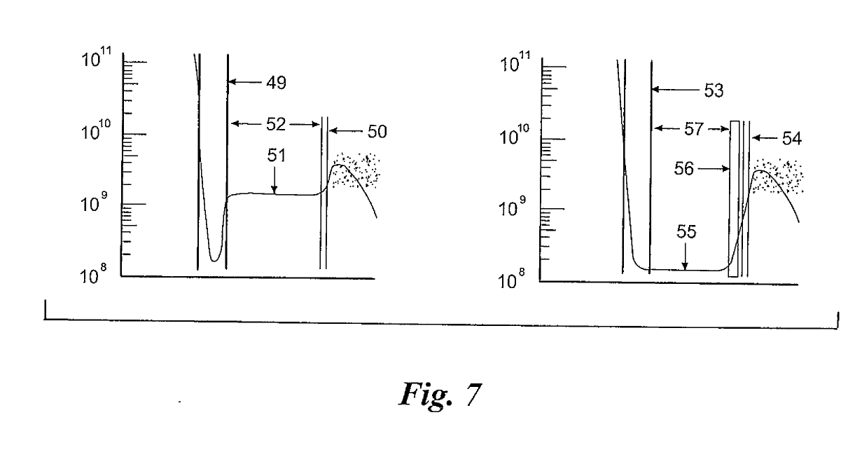

Hence results—and this is the major essential novelty of this application—the way to avoid an increase of the thermal flux in the RPV-wall towards its outer edge, and thus the way to shift the minimum of the build-up of ⁶⁰Co to this area: namely, an additional absorber, being attached to the liner of the Biological Shield will block the diffusion of thermalized neutrons from the Biological Shield back into the RPV-wall. Preventing the entrance of such reflected neutrons avoids the build-up of ⁶⁰Co in the outer region of the RPV-wall. The FIGS. 6 and 7 show this in detail:

FIG. 6 represents the radial cross section of the US-PWR as described in the quoted decommissioning report²⁵, with the course of the thermal neutron flux in neutrons/cm²sec (38) over the radius in meters (37). It shows the details of the thermal neutron flux (38) across the reactor core (39), the core shroud (40), the core barrel (41), the thermal shield (42), the RPV-cladding (43), the RPV-wall (44), the liner of the Biological Shield (45), the concrete of the Biological Shield (46) and the air gap to the Biological Shield (47).

The details within the circle (48) in that figure, as they are repeated in FIG. 7, now show the arrangements with a blocking absorber. On the left side of FIG. 7 there is its original arrangement, on the right side the arrangement with the proposed additional absorber (56), attached to the liner of the Biological Shield (54). The effect of this absorber is, as noted, the lowering of the thermal neutron flux (55) by blocking off the diffusion of thermalized neutrons back from the Biological Shield into the RPV, thus preventing the rise of the thermal flux toward the outer side of its wall. The overall design arrangements of the RPV itself (49, 52 resp.) and of the liner of the Biological Shield (50, 54 resp.) remain unchanged; the same also holding true with all the other details as they are shown in FIG. 6. Only the air gap (52) now includes the additional absorber (56). As an alternative, the suppression of the thermal neutron flux can be obtained by a direct addition of absorbing material into the liner and/or into the concrete of the Biological Shield.

If this attached absorber were boral, it could even with a thickness of a fraction of an inch absorb the thermal neutrons³¹. The minimum distribution of ⁶⁰Co, that now reaches the outer edge of the RPV, would then be even smaller than is indicated on the left side of FIG. 7, since the absorber (if it is a black absorber) would suppress practically completely the reflux of thermalized neutrons. (The shifting of the minimum of the thermal neutron flux, by the way, would have no influence on the embrittlement of the RPV since this depends on the fast neutron flux only that would not be altered by the proposed measures) A metal cutting process to reduce the content of ⁶⁰Co (and of the other neutron activated radionuclides) would then be done exclusively from the inside of the RPV (in the previous German patent, as mentioned, cutting/milling was planned to be done from both sides, from inside and from outside).

This work done only from the inside would simplify greatly the process of reducing the neutron induced activity, since there is within the RPV a well defined working space (albeit with different dimensions in the various cases). This inner milling ensures a uniform method of dismantling, dispensing with complicated cutting procedures from the outside of the RPVs. A separation of the RPV from the coolant lines would not be required. In performing the cutting process, as well in shipping the activated material into a LLW waste repository, the methods of the former German patent will be used. In particular they dealt with the under-water cutting of the material in layers (as proposed also in this present patent application), with the cutting procedures down to the minimum of the ⁶⁰Co-activity in layers of the same degree of activity, controlled by repeated measurements of activity and radiation doses; with the collection of the cut material by means of a suction device and compacting it into shielded containers; with its transportation into a LLW repository; with performing the cutting process also in less activated parts of the RPV; with the segmentation of the remaining RPV. This will dispense with complicated cutting procedures from the outside of the RPVs; and with the mounting and the moving of the cutting and milling tools there. All of these steps are adopted from the former German patent mentioned in this patent application. A cutting process from outside of the RPV is not included anymore.

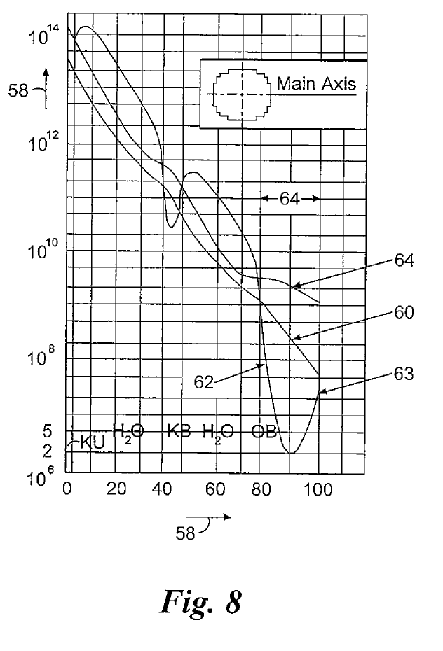

In order to assess now the thermal neutron fluxes and the possible reduction of the ⁶⁰Co-activity in large power reactors reliance is made now to the well documented graphical representation of such a reactor, the German KWU-DWR-1300 MWe plant, shown in FIG. 8. It shows, among others, the thermal neutron flux (neutrons/cm²sec) (62,63) in logarithmic scale (58) over its distance from the core edge. The thermal neutron flux within the RPV-wall (64) has three sources: the diffusion of thermal neutrons from the reactor core that form the left flange (62), the one from the Biological Shield that form the right flange (63) and thermalized neutrons from the fast flux (60) after passing the epithermal zone (61). The contribution from the latter source shrinks in the direction of the outer RPV-wall because of the decline of the fast flux in that direction. Both branches of the U-formed shape are approximations of exponential functions. Their representation as straight lines (in logarithmic scale) is plausible, because they are characteristic for the attenuation by an absorbing and scattering medium.

If it is assumed now that due to the additional absorber the right flank of the neutron flux (63) disappears; then the flux within the RPV-wall is represented by the left flank alone (plus the thermalized neutrons from the fast flux within the RPV-wall, as was mentioned). Then, a reduction of the RPV-wall from 23.6 cm down to 4 cm by the cutting process, evaluated from the approximating exponential function, will reduce the remaining ⁶⁰Co-activity to 0.07 promille of its original content, below the goal of SAFSTOR (as the former owner of the German patent pointed out, a wall reduction to 2 cm would still maintain the stability and tightness of the remaining RPV—that would mean a reduction to 0.03 promille).

It is also important to point out that of all the other radionuclides generated by the neutron activation the same percentage as that of ⁶⁰Co will be removed by the cutting/milling process, a result the cannot be achieved by SAFSTOR. It has to be pointed out, as well, that this assessment is not very precise due to the inaccuracies of the assumptions but there can be no doubt that the general findings will be roughly in this order of magnitude.

Considering the above, one can conclude that in all reactors with a Biological Shield and with RPVs made of steel, the remaining ⁶⁰Co-activity (and that of the other radionuclides) can be reduced also to less than 1/1000^{th} with the provision that the amount milled from the wall is limited only by the need to maintain its stability and its tightness. This reduction holds when the diffusion of the thermal neutrons from the Biological Shield is practically completely cut off. The proposed method of the reduction is the more meaningful the more the other radionuclides and those in the inner plating are also reduced.

Also in nuclear power plants that will be still in operation for 20 years or more, the blocking off of the diffusion of thermal neutrons from the biological shield into the RPV-wall can shift the minimum of the ⁶⁰Co-activity to the edge of the RPV-wall when the attachment of an absorber to its liner is technically and radiologically possible. The increased outer branch of the ⁶⁰Co-activity will then shrink by natural decay since no further activation due to incoming thermal neutrons takes place. In the KWU-PWR plant mentioned before, for example, after about 20 additional years of operation the outer peak of the ⁶⁰Co-activity will shrink as described by a factor of 16 and then the activity at the edge of the RPV will reach the value of the minimum activity that was originally inside the wall.

In new nuclear power plants three variants to suppress the formation of ⁶⁰Co can be considered: the attachment of an absorber (may be Boral) to the liner of the Biological Shield; the inclusion of an absorbing material into that liner; and/or the addition of an absorbing material into the concrete of the Biological Shield. The latter variant could have the advantage of minimizing or suppressing the build-up of ⁶⁰Co in the Biological Shield (amounting originally to up to 1/15^{th} of the content in the RPV). This would also facilitate an accelerated removal of the concrete, its being less burdened by radiation, and removed by methods of the state of technology. Choosing one or more variants is also dependent on the progress of the construction of the plant—if it is very advanced, the first method mentioned here would be preferable. In general, the minimizing of the ⁶⁰Co-content might serve later for an accelerated D&D of nuclear power plants as a whole.

### 5. POSSIBLE BACKLASH TO THE DISTRIBUTION OF THE REACTOR POWER

In contrast to the usual application of a reflector to achieve an optimization of the power distribution (i.e. by flattening) of a reactor, in this case an absorber attached to the “reflector” (i.e. to the Biological Shield) should lead to a reduction of the thermal neutron flux in a specific area (i.e. at the outer edge of the RPV). The question arises whether this might even produce an unwanted backlash to the optimization of the power distribution of the reactor. Its importance to the flux distribution is namely the opposite of a power distribution—namely the reduction of the thermal neutron flux on the outer side of the RPV. It can be assumed that there will be no negative backlash to the power distribution of the reactor. The graphical representations of the fluxes of the reactors, for example as shown in FIG. 8, show that the use of the additional absorber is exclusively intended to prevent an outer rise of the flux only within its limited area. Any backlash would be confined to a few mean free paths of the thermal neutrons.

Beyond this qualitative assessment a quantification of such possible backlashes to the distribution of the reactor power can be assessed analytically by means of the perturbation theory. The local reduction of the thermal neutron flux in the vicinity of the cover of the Biological Shield can be considered to be a small perturbation of the overall thermal flux distribution. As such it is, according to the theory, weighted by the square of the local neutron flux³². This flux, having the values of the modem KWU-PWR under consideration, is at the location of the absorber (FIG. 8) five to six orders of magnitude below the thermal neutron flux within the core. So the weight is 10 to 12 orders of magnitude less than that of the core. Therefore it is theoretically insignificant, i.e. non-existing.

### 6. MINIMIZING THE RADIATION BURDEN

The information in this chapter, unless quoted specifically, is taken from a publication of the Office of Technology Assessment of the U.S.Congress³³. It is plausible that demolition activities in Nuclear Power Plants, if undertaken shortly after the final shutdown, lead to higher radiation doses than if undertaken with SAFSTOR after 50 to 60 years. This assumption, however, is oriented to collective doses, but it has to be emphasized that it is individual doses that are the focus of licensing processes and they are, by experience, similar to those produced during normal operation of nuclear power plants. They are the regulatory basis of radiation protection and are determined not only by the activity to be dealt with but also by the optimized measures for radiation protection, by the development of the state of the art, the working steps and times and by the various tests, and so on. They are subject to the ALARA-principle. And even the collective doses of the replacement of steam generators (considered here, for instance, as an example for D&D) were by such measures progressively reduced. In six US-PWRs the collective doses during such replacements, produced from 1984 to 2005, dropped from 12.07 to 2.4 person-Sv. This would make SAFSTOR seem to be the optimum variant. But the individual doses of the personnel remained within the same range—and they are the accepted risk. In any case it has also to be emphasized that after SAFSTOR there follows DECON also leads to a radiation burden, as will later be shown with TMI-2, BR-3 and KRB-A.

The D&D of the RPV is in any case preceded by the removal of the used fuel and of the reactor internals that are both much more activated than the RPV; the state of technology methods to remove them are steadily in progress (however, not part of this patent application). The removal of used fuel (containing the highest amounts of activity) is routinely carried out. However, the most dramatic case of fuel removal is that of Three Mile Island 2 (TMI-2), a far from routine situation and here of highest interest. The fuel removal and that of the reactor internals were remotely controlled from a working platform high above the water-filled RPV, an especially demanding work, since the reactor internals and 20 tons of the fuel were extensively destroyed, molten into one another and frozen into the lower plenum. The clean-up arrangement at TMI-2 has a resemblance to this patent application. The water filling over the RPV and the working platform above it also served, most importantly, as radiation shields³⁴. TV displays of the working actions, computer-aided methods, remote control of the demolition tools, and the shipping off the activated material in shielded canisters resemble the here proposed dismantlement arrangements as shown in FIG. 1. The values of the radiation burden measured at TMI-2 can be seen to be conservatively overestimated for the dismantling process considered here.

From the data on the clean-up of TMI-2, those are quoted here that concern the emptying of its RPV. This work was done in 1984-87, beginning five years after the accident. The data are conservative insofar as they also included major decontamination tasks in the rest of the reactor building (for example surface contamination, the cleaning of water and so on). The whole body doses any one of the personnel was subject to was 37 mSv. According to ICRP the permissible individual occupational dose is 20 mSv/year, to be averaged over 5 years³⁵. The industrial mean value of radiation burden, however, could be retained to here. The doses at TMI-2, due to the imponderables of that accident, can be considered conservative for dismantling the RPV proposed in this patent application because of the similar dismantling arrangement. Doses at TMI-2 were as follows: 0.0002 mSv/hr at the top of the platform, 0.21 mSv/hr at the opening of the platform when removing the canisters, and 0.36 mSv/hr three meters away from the canister transport³⁶. These values were achieved by applying the ALARA principle according to ICRP60, and they can be considered as conservatively approximate values here.

It can be seen also that these doses at TMI-2 are comparable to those resulting from the deconstruction of a non-damaged nuclear power plant: At Gundremmingen KRB-A, for example, the highest doses were registered when dismantling the feedwater sparger in the RPV with a mean collective dose of 0.22 mSv/hr (1.3 Sv in 6000 hr), for dismantling the RPV a dose of 35 mSv per person (246 mSv for 7 persons³⁷) is assumed. This is comparable to the values at TMI-2. At the dismantling of BR-3 in Belgium the cumulative dose was 52 mSv (this is insofar remarkable as the contact dose at the midplane outside of the RPV was 2600 mSv/hr)³⁸. Since the doses at the accident-related case of TMI-2 and at the planned dismantling of KRB-A and BR-3 vary around a rather narrow band, one might expect that similar limits can be kept during the dismantling process of a large RPV. Above all it is plausible that doses during dismantling processes remain within the range of doses during the normal operation of Nuclear Power Plants.

SAFSTOR is intended to take 50 to 60 years, besides not being a too well defined option. It is a hot/cold standby phase with minimal decontamination processes or an enforced custodian phase with extensive decontamination³⁹. It does not include dismantling proper, so the cumulative doses over that time are smaller than in DECON, about a fourth of those with PWRs, a fifth of those with BWRs. In DECON these doses are related to the dismantling of the plant while in SAFSTOR they are related to storage. So whatever more or less intense work of decontamination is done to reach the goal of the monitored and preserving state SAFSTOR, it must be followed by DECON for a complete dismantling of the plant and this means that an additional radiation burden will ensue, depending on the content of the work done before during SAFSTOR. Therefore from a radiological point of view both phases are interrelated in a way that their doses in sum they might approach each other and perhaps get closer to that of DECON were this the D&D option right from the beginning. In any case this makes plausible the opinion of the Office of Technology Assessment of the U.S. Congress that the risk during dismantling the personnel is exposed to will be analogous to the risk the personnel is exposed to during the normal operation of the plant.

Additional details ought to be mentioned, too. Even in case it is intended to transfer an RPV as a whole (including the reactor internals) to a waste depository (such as was done with the RPV of Trojan), the proposed method of shifting the minimum of the activation to the outer edge of the RPV by the proposed absorber(s) is of advantage since it reduces the contact dose on the outside of the RPV, thereby simplifying the precautions necessary for transportation. The radiation doses on the outside would drop then by a factor of about 20.

In conclusion: the radiation burdens of the personnel in case of a deconstruction after an emergency (such as TMI-2 within 10 years) and that of a regular demolition (such as KRB-A after 20, BR-3 after 30 years) do not differ from each other too much. It can therefore be concluded that the radiological burdens of the personnel at the deconstruction of a Nuclear Power Plant as proposed here will most likely lie within this band, it is done within DECON or after SAFSTOR. The radiation burden to the population is in both cases insignificant. In respect to radiation protection there ought to be nothing that would hinder an accelerated dismantling of the plant.

### 7. STATUS AFTER CARRYING OUT THE PROPOSED MEASURES

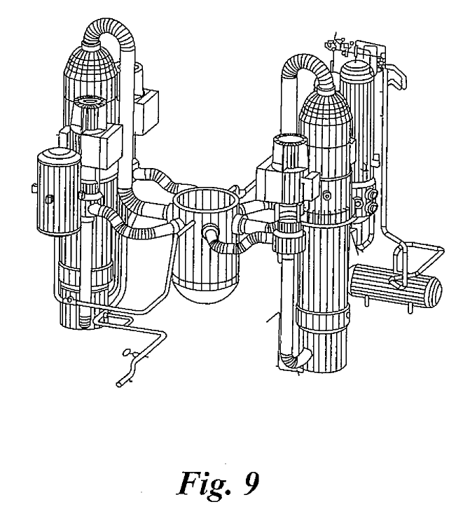

The proposed cutting/milling is by itself an autonomous method, but it should be, as it will be shown, also an integrating part of an accelerated dismantling of a complete nuclear power plant after its final shut down. Prior to the suggested means of dismantling the RPV, a surface decontamination of the inside of the closed primary system should be performed (using the reactor coolant pumps as suggested by EPRI¹⁶), followed by the removal of the peeled off material via the water clean-up system and its conditioning and transfer to a waste repository. After the lid of the RPV is removed and the fuel and the internals are cleared away, the open RPV will be filled with water as a precondition for carrying out the cutting/milling procedures as suggested. In FIG. 9 (depicting the primary system of TMI-2⁴, which, however, is similar to other LWRs; here with the steam lines not shown) it is easy to see that the cutting/milling procedure exclusively from the inside of the RPV alone greatly facilitates the procedures (among others, the steam lines alone would impede a cutting process from the outside as proposed in the former German patent). After the described reduction of material and activity, the primary system is reduced in substance and activity and it is then filled up to the flange with water and is stable and watertight. The following state has been achieved:
1. ⁶⁰Co is now reduced in the RPV to less than a 1/1000^{th} of the original content, thereby obtaining the reduction goal of SAFSTOR in the same time as in DECON.
2. An analogous reduction is achieved in the RPV with the longer lived radionuclides, such as ⁶³Ni and ⁹⁴Nb, surpassing substantially the reduction goal of SAFSTOR
3. The whole process of the reduction by cutting/milling is achieved by taking advantage of the water-tight contour of the primary system, and by maintaining its structural stability as a working basis
4. The whole process of the reduction by cutting/milling is achieved within the intact reactor safety containment, thereby maintaining the radiological safety of the personnel and of the public.
5. The whole process of the reduction of the activated material takes place under water with simple, remotely controlled rotationally operating tools by milling/cutting, thereby avoiding the formation of smoke and aerosols.
6. The open RPV has been reduced in weight, dimensions, and, of course, activity by milling/cutting exclusively executed from the inside, the lid is removed, the RPV filled up to the open flange with water.
7 The radiation burden of the personnel is not higher than it was during the clean-up of TMI-2, due to the similarity of the work steps, the transportation paths, the shielding, the water-shield, and the working platform.
8. The removed material is in the form of cuttings deposited under water, and will be partitioned into activity classes (according to FIG. 2; for example into >100 Ci, 50-100 Ci and so on), collected by suction devices, compressed into shielded canisters and shipped to a waste disposal.
9. The cutting/milling process might not be limited to the more highly activated parts of the RPV only, but could be extended, if beneficial for an optimal weight reduction, to its less-or-inactivated parts.
10. The reactor safety containment as well as the auxiliary systems (cranes and hoists, electric and electronic systems, heating, cooling, ventilating, air conditioning [HVAC], metrology installations, spare parts, radiation protection, controlled areas and so on) are still fully operable and could be used for a subsequent dismantling of the primary system.

### 8. THE POSSIBILITY OF AN ACCELERATED D&D OF A NUCLEAR POWER PLANT

The amount of ⁶⁰Co, as previously mentioned, is clearly the most important reason to give preference to the method SAFSTOR when dismantling a Nuclear Power Plant. When ⁶⁰Co, however, is significantly reduced by the method proposed here, then the variant DECON might become interesting. In this case there would be the following point of departure: The primary system (with the milled reactor pressure vessel) continues to be a tight envelope; all the systems and installations are still operable, such as the reactor safety containment, the controlled area and the auxiliary systems (cranes and hoists, electric and electronic systems, heating, cooling, ventilating, air conditioning [HVAC], metrology installations, spare parts, radiation protection, controlled areas and so on), In addition-the mobile activity (fuel, ion exchangers and so on) and the mobilizable activity (reactor internals) are removed according to the state of technology.

The continued sequential procedure of dismantling will then be represented in the following patent claims, to which reference is given here. It is assumed that one or several of the methods absorbing the thermalized neutrons from the Biological Shield, described in chapter 4, last paragraph, having been already implemented. This will have been realized by patent claim 1, to be followed in new reactors to be built or being in the process of building by patent claims 2 and 3, or in operating reactors, if technically possible, by patent claim 4. After that the dismantling might be carried out in the following sequence:

1. Decontamination of the inner surface of the whole closed Primary System by one (or several) of the methods according the present state of technology, using the reactor coolant pumps as proposed by EPRI as soon as possible. A Decontamination factor of between 2 and 80 can be achieved⁴¹ (the method “In Situ Hard Chemical Decontamination” of Studsvik Radwaste & Framatom⁴² even quotes a method usable on a major scale with a decontamination factor of 5000, and with a wetting time for the steam generator tubes of 36 to 72 hours). The activity not removed from the surfaces stays attached to it (and can in a later step be fixed by coating). The material detached from the surfaces can be removed via the water clean-up system, attached to an ion exchanger, conditioned and transferred to a waste repository. The reactor containment, the control area and the auxiliary systems are operable.

2. The reduction of the inventory of activity, especially of ⁶⁰Co, will be carried out after opening the lid of the RPV within the intact primary system as it is shown in FIG. 9 (which leads to patent claim 5), performed according to the proposals mentioned in this patent application and being remotely controlled from a working platform above shielding water. As mentioned, the reactor safety containment, the control area and the auxiliary systems are fully operable (leading to patent claim 6). The mechanical reduction proceeds as long as the primary system bears the mechanical loads and ensures its water tightness (as in patent claim 5). The activated material is taken off in layers, sorted according to the activity classes, collected by suction, pressed into shielded canisters and shipped away to a waste repository. So the remaining activity of ⁶⁰Co and of other radionuclides will not surpass 1/1000^{th} of the original content and will thereby correspond to the target set by SAFSTOR, however after a much shorter time. Having performed these steps, the Primary System (including the RPV), with greatly reduced activity retains the intact contour of the (original) Primary System. It is located within the plant as are the intact infrastructure, the control area and the reactor safety containment. It should then be possible to perform D&D of the entire plant within the phase DECON (this leads to patent claim 7). In that case the following steps might follow in sequence:

3. By means of the continuously operable infastructure, the large and heavy components such as the steam generators, the coolant pumps, and the pressurizer will be disassembled. The steam generators can be removed as one piece each (their exchange is possible also during the operational time of the plant). Such a procedure ought to be possible also with the other heavy components. After being decontaminated according to the state of technology, these components can be disassembled and transferred into a Low Level Waste repository. Dismantling the working platform for the material reduction ought to pose no problems.

4. The remaining Primary System, (possibly with some remaining activity fixed to its inner surface), as well as the RPV with a residual amount of activity, both having in any case been relieved of their predominant amount activity, will be segmented using the infrastructure still ready for operation. A possibility to do the segmenting is by means of kerfing¹⁸, the separated parts being transferred into a LLW repository. The technical means available today, as well as the technology of radiation protection, ought to enable the D&D. Impediments could arise in the concrete structures, that however, can be segmented by methods of the state of technology—apart from the Biological Shield, (if this is not relatively free of activity by means of patent claim 1a).

5. Concerning the Biological Shield, in retired or still operating plants with about 15% of the content of the ⁶⁰Co of the original RPV still its biggest reservoir of activity, a remotely controlled segmentation might be advisable. Also for that purpose an intact reactor safety containments and the intact systems of the infrastructure would prevent the spread of activity. In new Nuclear Power Plants the Biological Shield might have been seeded (as in patent claim 1a) with an absorbing material that reduced the activity. In older plants, if their design permits, an attachment of an absorbing cover to the Biological Shield (as in patent claim 1b) might reduce at least some of its neutron induced activity by enhancing the neutron diffusion, thereby also facilitating the dismantling.

6. The removal of the remainders of the structures, in particular the reactor safety containment, should be done after a surface decontamination aiming to the exemption limits for activity. This will be done according to the state of technology, the pieces possibly shipped to a LLW deposit Blasting technology might be of importance in the case of especially big structures, unless they might be of value for later use.

These remarks are not meant to minimize the problems associated with an accelerated D&D; many of which must be evaluated by exact analysis. They are, however, intended to show that the proposed methods in this patent application ought to facilitate an immediate entry into the phase DECON. This holds for the D&D of retired Nuclear Power Plants with light water reactors, in a modified form maybe also for other reactors. It definitely seems to be advantageous (and profitable) for manufacturers of nuclear power plants when an accelerated D&D of technical installations is already provided for in their state of design.

The most important question, however, here and anywhere else in technology, is the cost. On it depends whether or not a project comes to realization. Therefore it is reasonable to deal with at the end of these deliberations.

### 9. POSSIBLE REPERCUSSIONS ON THE PLANT DESIGN AND ON THE COST

The information in this chapter, unless otherwise indicated, is also extracted from the publication of the Office of Technology Assessment of the USCongress³³.

Manufacturers of Nuclear Power Plants are understandably not enthusiastic about interferences with the design of their plants. Any engineer involved in the layout would be horrified at the many cumbersome interactions a new proposal might have with the general concept. Such effects, however, are not foreseen in this application. Attaching an absorber to the liner of the Biological Shield, or adding an absorbing ingredient to that liner, or adding an absorbing ingredient to the concrete in the Biological Shield (if the state of construction still permits that) will scarcely have any repercussions on the design of a new Nuclear Power Plant. No matter what form the absorber has, it is not subject to any undue mechanical, thermal or physical loads. However, the inclusion of an absorber into a plant already in operation might pose problems in view of the design and of the radiation protection requirements, but in any case it can be done only if the design permits such an inclusion.

It is not possible to determine exactly the requisite expenses for the D&D; for example the costs of labor, the requirements for radiation protection, local requirements, fees for the disposal of waste material, the time factor, and so on. In view of the two dismantling options, DECON and SAFSTOR, the following ought to be considered⁴³:
. . . Although the cost for immediate decommissioning can be estimated within an acceptable degree of accuracy, there are uncertainties in estimating the cost of controlling a site for long periods of time. In addition, factors such as exceedingly high annual escalation of LLW disposal rates can negate any postulated savings from the deferred decommissioning alternative, even if reduced waste volumes are a result of the deferred decommissioning. . . .

As an example, the volatility of the cost of D&D can be seen clearly at Trojan 1, as was mentioned before: The costs were assessed in 1986 as 103.5 Million $US, 10 years later, 1996, as 429 Million $US⁴⁴, that is an increase of 15.3%/year. The plant was closed down after 17 years of operation because of legal objections in 1996 and was replaced by a more cost-saving alternative. In 2006, as mentioned, the RPV was shipped away as a single piece (including the reactor internals) to a LLW disposal site (and the rest of the plant?). Also this example shows that options with an extended time factor lead to high cost increases, even when the largest component, the RPV, was supposedly shipped away in a cost-saving manner as a single piece.

A long delayed dismantling of the whole plant after SAFSTOR, with the intended restoration of the “Greenfield State”, requires considerable effort in administrative and technical infrastructure. One must consider the installation after many years of a new technical and logistic organization, new personnel, the revitalizing, the replacement and/or the quality of the electrical and mechanical equipment, the renewing of cranes and hoists, of the (re)installation of the systems of radiation protection and surveillance and so on: The imponderables become less determinable the longer the delay lasts. All these systems must be revitalized, starting from an indefinite standstill. On the other hand, with an immediate decommissioning following shutdown, their proper functioning can be assumed.

A survey of the costs of D&D of Nuclear Power Plants in the USA, collected by the Pacific Northwest Laboratory (PNL) shows the following results:
for 47 PWRs: $191/kWe, standard deviation $65/kWe (monetary value of 1989)
for 26 BWRs $248/kWe, standard deviation $126/kWe (monetary value of 1989)
   Accordingly, the average total expenditure for the decommissioning, the dismantling and the restoration of the Greenfield State of a 1,000 MWe-LWR-plant in 1989 would be 211 million US dollars (with a considerable standard deviation of 96 million $). A break down into DECON and SAFSTOR was evidently not done by PNL but it seems likely that the costs were incurred by DECON since the study dealt with dismantling processes proper. If, however, increasing costs for a longer-lasting deconstruction process might be hidden in the reckoning of the standard deviation, then the following paragraph suggests that this was not the case due to enormous cost increases with long delayed D&D. The imponderables and the vagueness grow with complex tasks, such as dismantling of the RPV or of the steam exchangers.

The expenditures of a D&D of a nuclear power plant are the less predictable, the longer this process lasts. In the case of Seabrook (PWR, 1150 MWe) it was shown that the dismantling costs of an assumed 324 Million US dollars in the year 1991 would rise after 35 years of SAFSTOR-to $1.6 billion US dollars. These include interest rates of 4.7%/year. Had one chosen the method DECON over a period of 10 years, the increase would have reached with the same interest rate as much as 511 million US dollars. This certainly sounds a bit random due to the lack of congruence of both methods. There are other imponderables that are the less predictable the longer they are projected into the future. There is, for example, the increase in the fees for a LLW disposal that are a major part of the D&D-expenditures which rose within only 13 years by a factor of 25. This is a rise of 21.8%/year. This alone would give preference to DECON over SAFSTOR. Concerning the cost of the LLW storage it can be assumed that partitioning the 60Co into activity classes would also render a cost decreasing effect.

Predictability of the expenditures is a principle in making commercial assessments und that is the less sure the longer one projects into the future. For this reason alone DECON would be preferable to that SAFSTOR. In view of the high fees for using a LLW disposal site one might also add that after a metal cutting of the RPV, a partitioning and storing of the cuttings sorted in categories of activity (as seems advisable according to FIG. 2) might have a substantial cost reducing effect on storing vis a vis the storing of a RPV as one piece in a LLW disposal site.

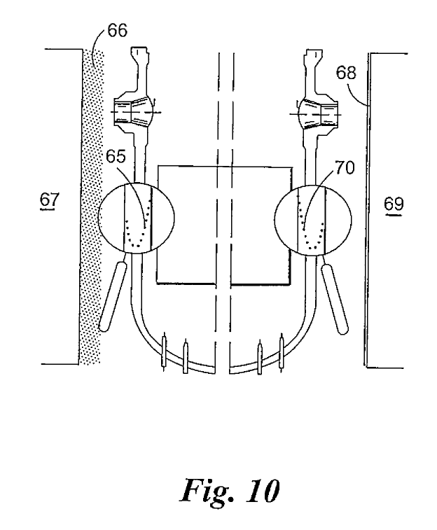

Precise expenses incurred by using this proposal are not included in the present considerations. However, adding an absorber in one of the suggested ways, as well a milling/cutting process from the inside of the RPV alone, done with relatively simple, rotationally symmetric tools and processes to be used could to be cost saving. And even if a decision to dismantle the RPV by metal cutting as suggested by this proposal might not yet be possible in the original design of a plant, the inclusion of one or several of the proposed absorbers into the construction is not very cost intensive and would keep the option of dismantling by metal milling/cutting open for the future.
¹A general resumee. in E. Bensoussan, N. Reicher-Fournel: Der Rückbau von Reaktoren und die Behandlung der Abfälle (The dismantling of reactors and the treatment of waste), atw 50. Vol (2005) number 1
²ASME Nuclear Facility Decontamination and Decommissioning Handbook, Chapter XX. Decision Processes for Prompt vs. Delayed Decommissioning, Download Dec. 30, 2007
³Winter Meetin 1994 of the American Nuclear Society: “Decommissioning, Decontamination and Environmental Restoration at Contaminated Nuclear Sites (DDER-'94)”. Summary Document, 2 Volumes, Presentation in Vol. 1, pp. 138-145, & Transactions 1994 Winter Meeting, pp. 659-661
⁴Nuclear Energy Institute (NEI, USA): Key Issues, Decommissioning of Nuclear Power Plants, Nov. 18, 2007
⁵U.S.NRC: Fact Sheet on Decommissioning Nuclear Power Plants, 8 p., Jan. 22, 2008
⁶To the present state of specific reactors: Decommissioning Nucleai facilities, Nuclear Issues Briefing Papers, December 2007,
⁷F.-W. Bach et al.: Leistungsfähige Rückbautechnologien—Plasmaschmelzschneiden. Kontakt-Lichtbogen-Metall-Schneiden (CAMC) und Kontakt-Lichtbogen-Metall-Trennschleifen (CAMG), ATW 51. Vol. (2006), part 10, Okt.
⁸F.-W. Bach et al.: Schneid-und Dekontaminationstechnologien für den kostengünstigen Rückbau kerntechnischer Anlagen, ATW 52. Vol (2007), part 4, April
⁹For example: Borchardt, Raasch: IRDIT Project: Innovative Remote Dismantling Techniques, Table 1EWN, Germany
¹⁰SCK-CEN, Scientific Report 1996, Decommissioning of the BR3 PWR, Download Mar. 7, 2008
¹¹V. Massaut, A. Lefebvre: The BR3 Pilot Dismantling Project: Experience in Segmenting Highly Radioactive Internals ANS-Winter Meeting 1994
¹²CND, The KPB-A (Gundremmingen) Pilot Dismantlich Project
¹³Gundremmingen KRB-A, Dismantling techniques for activated components
¹⁴Large Comp Removal/Shipping, Yankee Removes Reactor Vessel, Download Mar. 7, 2008
¹⁵POE: Trojan Nuclear Plant Decommissioning, 2006
¹⁶Electric Power Research Institute, Ch. J. Wood, S. Bushhart: EPRI's Decommissioning Technology Program, Radwaste Solutions, pp. 30-35, July/August 2006
¹⁷German patent DE 44 37 276 C 2: Verfahren und Vorrichtung zur Entsorgung einer aktivierten metallischen Komponente eines Kernkraftwerks (method and device for dismantling an activated component of a nuclear power plant) Patent granted Apr. 6, 2000, Application 18. 10. 1994, Patent owner S.A.S Anlagen-und Stillegungstechnik GmbH, Linz, AT, Inventor DI Walter Binner, Wien, AT. No fees were paid from 2003 on (without notification to the inventor)
¹⁸Watanabe Masaaki et al: Technology development for cutting a Reactor Pressure Vessel using a mechanical cutting technique, Science Links, Japan, Journal of the RANDEC, Vol. 23,
¹⁹Telefax from VOEST-ALPINE MCE, DT 4 Mr Schedelberger, 24.10.94, 10 pages
²⁰VOEST-ALPINE MCE, Zerspanungstechnologie zur mechanischen Zerlegung von dickwandigen Behältern am Beispiel eines Reaktordruckbehälter (Cutting as a mechanical demolition of a reactor pressure vessel), March 1996
²¹IAEA, Technical Report Series 395, State of the Art Technology for Decontamination . . . , 1999
²²Conference Safe Decommissioning for Nuclear Activities, Berlin 14-18 Oct. 2002, T. Ishikura, r. 193ee
²³S. Thierfeld: Qualitätssicherung und Rückbau (QA and dismantling): Symposium 2006. ATW 51. Jg. (2006) Heft 10,
²⁴Working Party on decommissioning and Dismantling (WPDD), NEA/RWM/WPDD(2006)5
²⁵NUREG-CR-0130, June 1978: Technology, Safety and Costs of Decommissioning a Reference PWR, Vol. 2, FIG. C.1-2
²⁶NUREG/CR-0672, October 1979, Technology, Safety and Costs of Decommissioning a Reference BWR, Vol. 2, FIG. E.1-3
²⁷J. Koban: Neutronenflussrechnungen von Strahlenschädigungen eines RDB (Flux calculation & radiation damages of a RPV, shown at a KWU-1300-MWe-DWR), ATKE Bd. 29 (1977), S. 159-162, FIG. 2
²⁸Glasstone-Sesonske, Nuclear Reactor Engineering, 1967, p. 602, FIG. 10.9
²⁹J. R. Lamarch: Introduction to Nuclear Reactor Theory, Addison-Wesley Publishing Company, 1965, Chapter 10
³⁰S. Glasstone, M. C. Edlund: The Elements of Nuclear Reactor Theory, D. Van Nostrand Company, 1952, Chapter VIII
³¹Etherington (Editor): Nuclear Engineering Handbook, 2-34, 10-71, 1958
³²Etherington (Editor), as quoted: 6-21 & J. R. Lamarch, as quoted: 15-3, esp. (15-55)
³³U.S. Congress, Office of Technology Assessment: Aging Nuclear Power Plants: Managing Plant Life and Decommissioning, 178 pp., September 1993
³⁴J. J. Byrne: TMI-2 Cleanup Program Post-1988, ANS Winter Meeting 1994, Proceedings pp. 215-218
³⁵D. J. Merchant: Workers Exposures during the Three Mile Island Unit 2 Recovery, Nuclear Technology, Vol. 87, December 1989, pp. 1099-1105
³⁶N. L. Osgood et al: Review of Radiation Shielding Concerns with the TMI-2 Defueling Systems, Nuclear Technology, Vol. 87, December 1989, pp. 556-561
³⁷Gundremmingen KRB-A, Dismantling techniques for activated components, Printout 2008
³⁸The BR3 dismantling operations and related techniques, http://www.eu-decom.be
³⁹R. E. Aker, A. L. Taboas: ASME Nuclear Facility Decontamination and Decommissioning Handbook, Chapter XX
⁴⁰Wolfgang, Patterson: Ex-Vessel Defueling for TMI-2, Nuclear Technology, Vol. 87, pp. 617 ff, November 1989,
⁴¹US Congress: Aging Nuclear Power Plant (as quoted), Table 4-3
⁴²In Situ Hard Chemical Decontamination” of Studsvik Radwaste & Framatom, Research Programme Decommissioning of Nuclear Installations, Luxembourg, 26-30 Sep. 1994, preprint pp. 353-364
⁴³Department of the Army (Corps of Engineers): General Design Criteria to Facilitate the Decommissioning of Nuclear Facilities, Chapter 2, Decommissioning Methods, TM 5-801-10, April 1992,
⁴⁴Portland General Electric, Trojan Nuclear Plant Decommissioning, 2006

1. A method of absorbing thermalized fast neutrons in a biological shield and/or avoiding their retro-diffusion into a reactor pressure vessel, which comprises at least one of the following steps:
a) admixing boron or an other neutron absorbing substance into concrete forming the biological shield,
b) adding boron or an other neutron absorbing substance into an inner liner of the biological shield,
c) attaching an absorber containing boron or an other neutron absorbing substance onto the inner liner of the biological shield.

2. The method defined in claim 1 wherein formation of ⁶⁰Co and other neutron-activated radionuclides, caused by the retrodiffusion of the thermalized neutrons from the biological shield inside the reactor pressure vessel, is shifted to to the outside of the reactor pressure vessel, according to step (a), step (b) or step (c) thereby minimizing the retrodiffusion of such neutrons from the biological shield into the reactor pressure vessel.

3. The method defined in claim 1 wherein formation of ⁶⁰Co and other neutron-activated radionuclides, caused by the retrodiffusion of the thermalized neutrons from the biological shield is achieved through a reduction of a flux of the thermalized neutrons, wherein the flux of such neutrons in the biological shield is minimized by admixing boron or another neutron absorbing substance into the concrete forming the biological shield according to step (a).

4. The method defined in claim 1 wherein a reduction or prevention of an an increase in formation of activated ⁶⁰Co and other neutron-activated radionuclides towards the outer wall of the reactor pressure vessel is achieved by avoiding, the rediffusion of the thermalized fast neutrons from the biological shield by attaching an absorber containing boron or an other neutron absorbing substance onto the inner liner of the biological shield according to step (c) in order to enable the reduction or prevention of an increase by the natural decay of ⁶⁰Co.

5. The method defined in claim 2 wherein following the shifting of the retrodiffusion of the thermalized neutrons to the outside of the pressure reactor vessel, ⁶⁰Co and other neutron activated radionuclides, to be sorted according to their activity classes, are removed from an opened reactor pressure vessel, which is emptied from fuel and reactor internals and filled with water up to the lid flange, the removal by mechanical means is done exclusively from the inside of the reactor pressure vessel, up to the proximity of the minimum of the activity that is shifted to the outer wall, with the goal of clearing down to about 1/1000^{th} of the original radioactivity under the provision that the mechanical stability and the tightness of the surface of the reactor pressure vessel is maintained.

6. The method defined in claim 4 wherein during dismantling of a finally retired nuclear power plant, the Reactor Safety Containment, the Control Area and the Auxiliary Systems (cranes and lifting devices, electrical and electronic systems, HVAC, radiation protection installations, decontamination systems and so on) stay intact and can be used to an extent required for the work to be done.

7. A method for accelerated total dismantling of a finally retired Nuclear Power Plant within the phase DECON, so marked in the USA, which comprises the steps of:
(I) absorbing thermalized fast neutrons in a biological shield and avoiding their retrodiffusion in a reactor pressure vessel by at least one of the following steps:
a) admixing boron or an other neutron absorbing substance into concrete forming the biological shield,
b) adding boron or an other neutron absorbing substance into an inner liner of the biological shield,
c) attaching an absorber containing boron or an other neutron absorbing substance onto the inner liner of the biological shield; and
(II) after emptying the Reactor Pressure Vessel from fuel and reactor internals and after a surface decontamination of the Primary System according to the state of technology, an imploding dismantling from the inside to the outside will take place so that subsequently this dismantling will be made possible under furthermore required readiness of the Reactor Safety Containment, the Control Area and the Auxiliary Systems as well as by the accompanying shipment of the released and shielded activity to a Low Level Deposit, with the goal of a reinstallment of the “Greenfield State” according to the state of technology or of further readiness for different use.
